(19) United States
(12) Patent Application Publication
(10) Pub. No.: US 2019/0079588 A1
(43) Pub. Date: Mar. 14, 2019

(54) MODULAR ACTIVITY MONITOR SYSTEM

(71) Applicant: FOTORAMA USA, LLC, Cupertino, CA (US)

(72) Inventor: Jose M. ZAVALA DEL MORAL, Mexico City (MX)

(73) Assignee: FOTORAMA USA, LLC, Cupertino, CA (US)

(21) Appl. No.: 16/082,762

(22) PCT Filed: Mar. 8, 2017
(86) PCT No.: PCT/US2017/021414

§ 371 Date: Sep. 6, 2018

Related U.S. Application Data
(60) Provisional application No. 62/305,237, filed on Mar. 8, 2016.

(51) Int. Cl. G06F 3/01; G06F 3/0346; G06F 1/16; G06F 17/30

(52) U.S. Cl. CPC G06F 3/017; G06F 3/0346; G06F 17/30861; G06F 1/1694; G06F 1/163

(57) ABSTRACT

A modular activity monitor system is provided having a sensor configured to gather user movement data when coupled to the user. A controller is coupled to the sensor and configured to store the user movement data. An electrically-operated component is configured to receive the user movement data from the controller and is operable based on the user movement data.

### CROSS-REFERENCE TO RELATED APPLICATIONS

The present application is a Patent Cooperation Treaty application that claims priority to U.S. Provisional Patent Application Ser. No. 62/305,237, filed Mar. 8, 2016 and titled “MODULAR ACTIVITY MONITOR SYSTEM,” which is herein incorporated by reference in its entirety.

### TECHNICAL FIELD

The present disclosure relates generally to activity monitors, and particularly to modular activity monitors movable between devices.

### BACKGROUND

Often, individuals may remain sedentary and not be physically active. Many people frequently desire to be more active and/or for their children to be more active. Utilizing accessibility to devices as an incentive may be useful in making individuals more active.

### SUMMARY

According to one aspect of the disclosure, a modular activity monitor system includes a first receiver, a second receiver, and a modular activity monitor configured to be movable between the first receiver and the second receiver to modify the operation of at least one of the first receiver and the second receiver. In some embodiments, the first receiver may be wearable by a user. Additionally, the first receiver may be an annular band. In some embodiments, the second receiver may be a toy or another electrically-operated product. In one embodiment, the first receiver and the second receiver are the same component, e.g. the receiver is coupled to and/or incorporated into the toy.

In some embodiments, the modular activity monitor includes a controller, a sensor, and a battery that powers the sensor and the controller. In an embodiment, the sensor detects movement and sends movement data to the controller. The controller is configured to receive data from the sensor and store movement data in a memory of the modular activity monitor.

In some embodiments, when the modular activity monitor is coupled to the annular hand, the sensor sends movement data to the first controller in response to movement of the user. The controller records the movement data in the memory.

In some embodiments, when the modular activity monitor is coupled to the second receiver, the modular activity monitor may send movement data stored in the memory to a controller of the second receiver. The controller may use the movement data to operate the second receiver in a mode associated with the movement data.

In one aspect, a modular activity monitor system includes a modular activity monitor configured to be coupled to a user. The modular activity monitor includes a sensor configured to gather user movement data when coupled to the user. A first controller is coupled to the sensor and configured to store the user movement data. A transmitter is configured to transmit the user movement data. The modular activity monitor also includes an electrically-operated component including a receiver configured to receive the user movement data. A second controller is configured to operate the electrically-operated component based on the user movement data.

In some embodiments, the modular activity monitor is configured to be coupled to an annular band that couples to the user. In some embodiments, the modular activity monitor is configured to be coupled to the electrically-operated component to transmit the user movement data from the modular activity monitor to the electrically-operated component.

In some embodiments, the transmitter is operable to wirelessly transmit the user movement data to the receiver. In some embodiments, the transmitter is operable to transmit the user movement data to the receiver via a radio frequency. In some embodiments, the transmitter is operable to transmit the user movement data to the receiver via an infrared frequency.

In some embodiments, the first controller is configured to calculate a user level associated with a threshold value of user movement data. The second controller is configured to operate the electrically-operated component in one of a plurality of modes based on the user level. In some embodiments, a plurality of user levels are each associated with exceeding one of a plurality of threshold values of user movement data. Each of the plurality of user levels corresponds to one of the plurality of modes of the electrically-operated component. In some embodiments, the second controller is configured to reset the mode of the electrically-operated component.

In some embodiments, the electrically-operated component is a vehicle. The plurality of modes includes a plurality of lighting configurations and sounds activated by the vehicle. In some embodiments, the plurality of modes includes a plurality of speeds of the vehicle. In some embodiments, the electrically-operated component is an action figure. The plurality of modes includes a plurality of lighting configurations and sounds activated by the action figure. In some embodiments, the plurality of modes includes a plurality of speeds of the action figure.

In some embodiments, the first controller is operable to transmit the user movement data to an electronic device through a first internet connection. In some embodiments, the second controller is operable to receive the user movement data from the electronic device through a second internet connection.

In another aspect, a modular activity monitor system is provided having a sensor configured to gather user movement data when coupled to the user. A controller is coupled to the sensor and configured to store the user movement data. An electrically-operated component is configured to receive the user movement data from the controller and is operable based on the user movement data.

In yet another aspect, a method of operating an electrically-operated component is provided. The method includes gathering user movement data with a sensor coupled to a user. The method also includes storing the user movement data in a controller coupled to the sensor. The method also includes transmitting the user movement data to an electrically-operated component. The method also includes operating the electrically-operated component based on the user movement data.

In some embodiments, the method includes coupling the sensor to an annular band that couples to the user. In some embodiments, the method includes coupling the controller to the electrically-operated component to transmit the user movement data from the controller to the electrically-operated component.

In some embodiments, the method includes wirelessly transmitting the user movement data from the controller to the receiver. In some embodiments, the method includes wirelessly transmitting the user movement data from the controller to the electrically-operated component via a radio frequency. In some embodiments, the method includes wirelessly transmitting the user movement data from the controller to the electrically-operated component via an infrared frequency.

In some embodiments, the method includes calculating a user level associated with a threshold value of user movement data. In some embodiments, the method includes operating the electrically-operated component in one of a plurality of modes based on the user level. In some embodiments, a plurality of user levels are each associated with exceeding one of a plurality of threshold values of user movement data. Each of the plurality of user levels corresponds to one of the plurality of modes of the electrically-operated component. In some embodiments, the method includes resetting the mode of the electrically-operated component.

In some embodiments, the method includes transmitting the user movement data from the controller to an electronic device through a first internet connection. In some embodiments, the method includes transmitting the user movement data from the electronic device to the electrically-operated component through a second internet connection. In some embodiments, the electronic device may operate a game and/or a level of a game based on the user movement data and/or the user level.

### BRIEF DESCRIPTION

The detailed description particularly refers to the following figures, in which:

FIG. 1 is a perspective view of a modular activity monitor in accordance with an embodiment and coupled to an annular band;

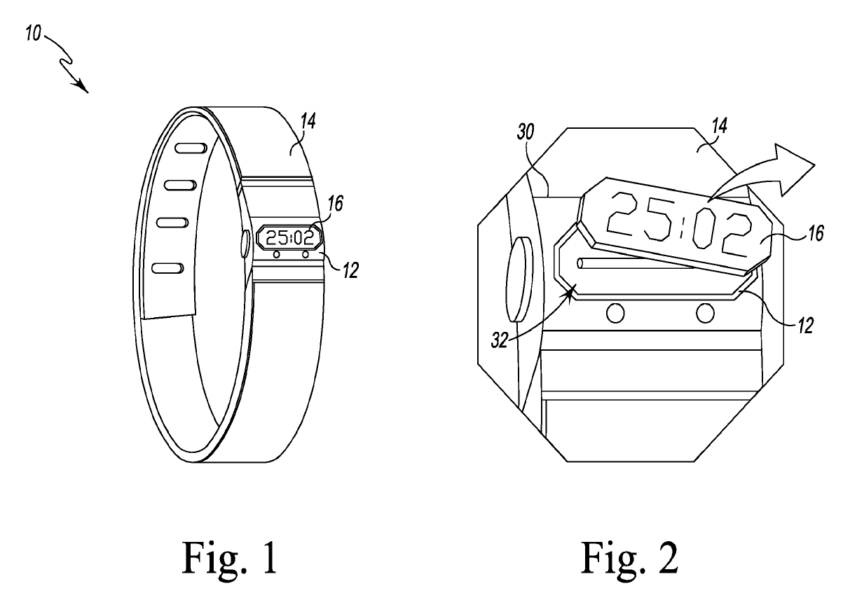

FIG. 2 is a perspective view of a modular activity monitor of FIG. 1 in accordance with an embodiment;

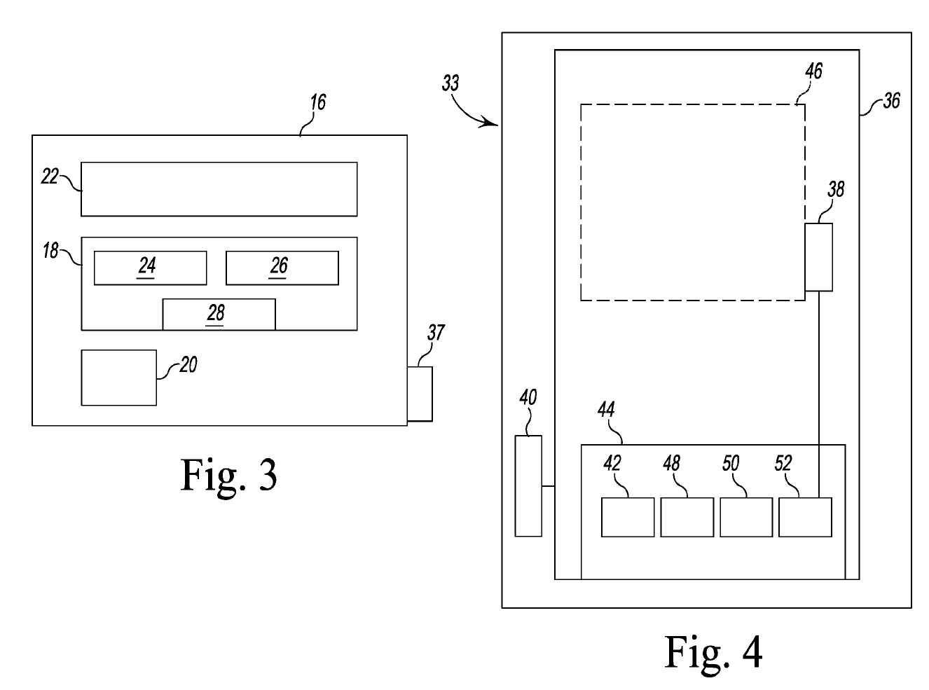

FIG. 3 is a schematic diagram of the modular activity monitor of FIG. 2;

FIG. 4 is a schematic diagram of an electrically-operated component in accordance with an embodiment;

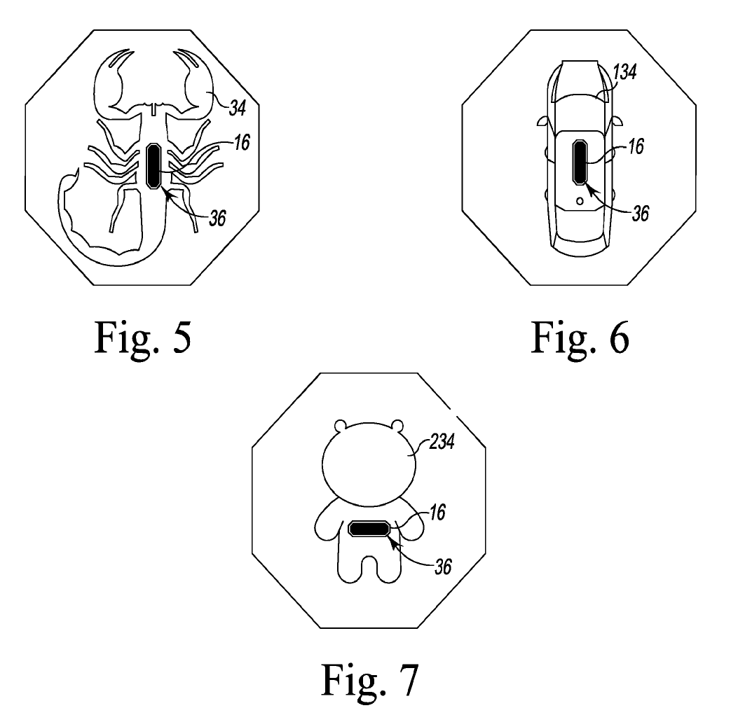

FIG. 5 is a perspective view of the modular activity monitor of FIG. 2 coupled to an electrically-operated component in accordance with an embodiment;

FIG. 6 is a perspective view of the modular activity monitor of FIG. 2 coupled to another electrically-operated component in accordance with an embodiment;

FIG. 7 is a perspective view of the modular activity monitor of FIG. 2 coupled to yet another electrically-operated component in accordance with an embodiment;

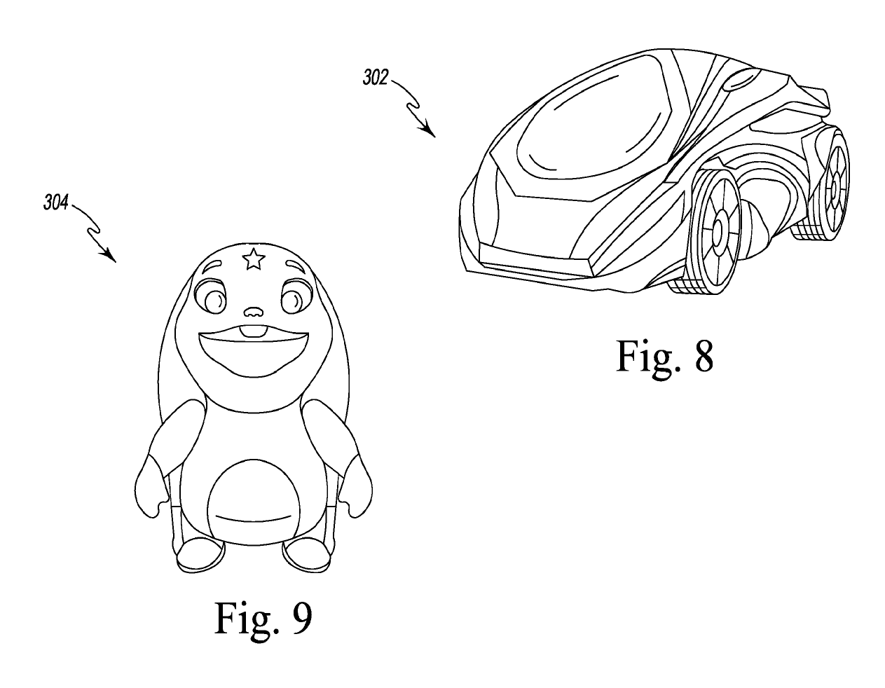

FIG. 8 is a perspective view of an electrically-operated component in accordance with an embodiment;

FIG. 9 is a perspective view of another electrically-operated component in accordance with an embodiment;

FIG. 10 is a perspective view of yet another electrically-operated component in accordance with an embodiment;

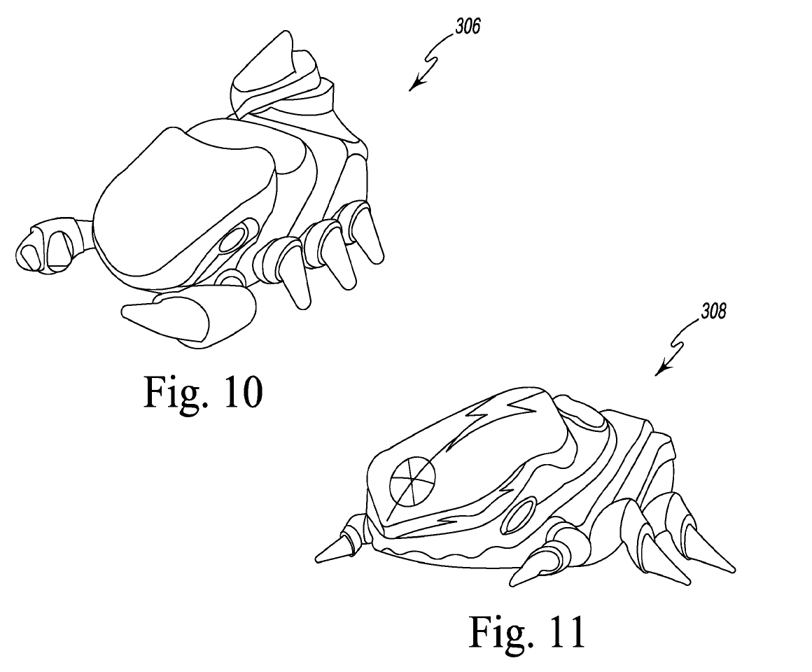

FIG. 11 is a perspective view of still another electrically-operated component in accordance with an embodiment;

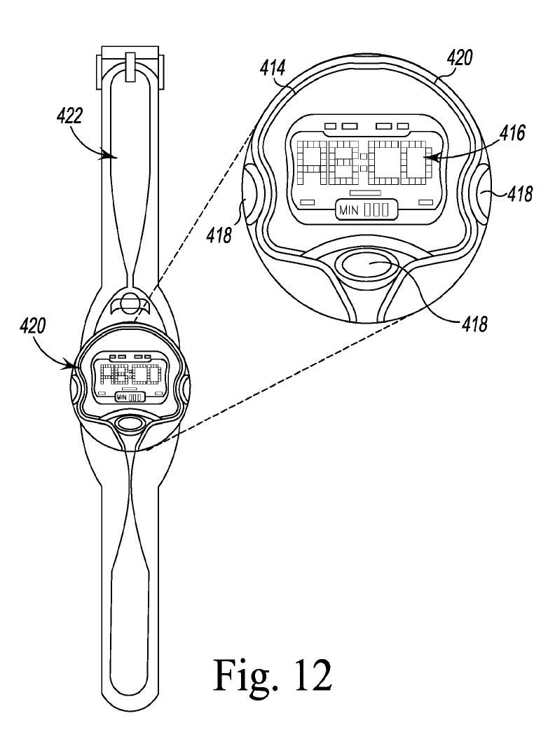

FIG. 12 is a perspective view of a further modular activity monitor in accordance with an embodiment an coupled to an annular band, with an exploded view of a modular activity monitor;

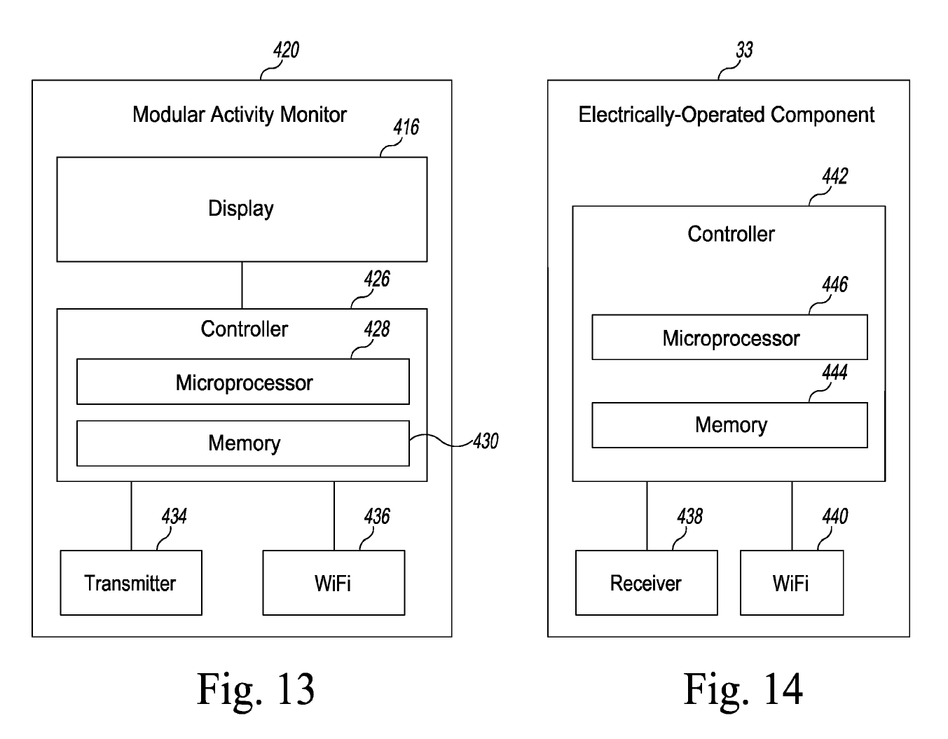

FIG. 13 is a schematic diagram of a modular activity monitor in accordance with an embodiment;

FIG. 14 is a schematic diagram of an electrically-operated component in accordance with an embodiment;

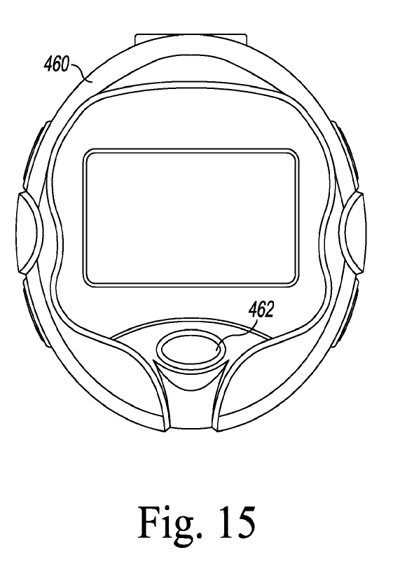

FIG. 15 is a perspective view of another modular activity monitor in accordance with an embodiment; and

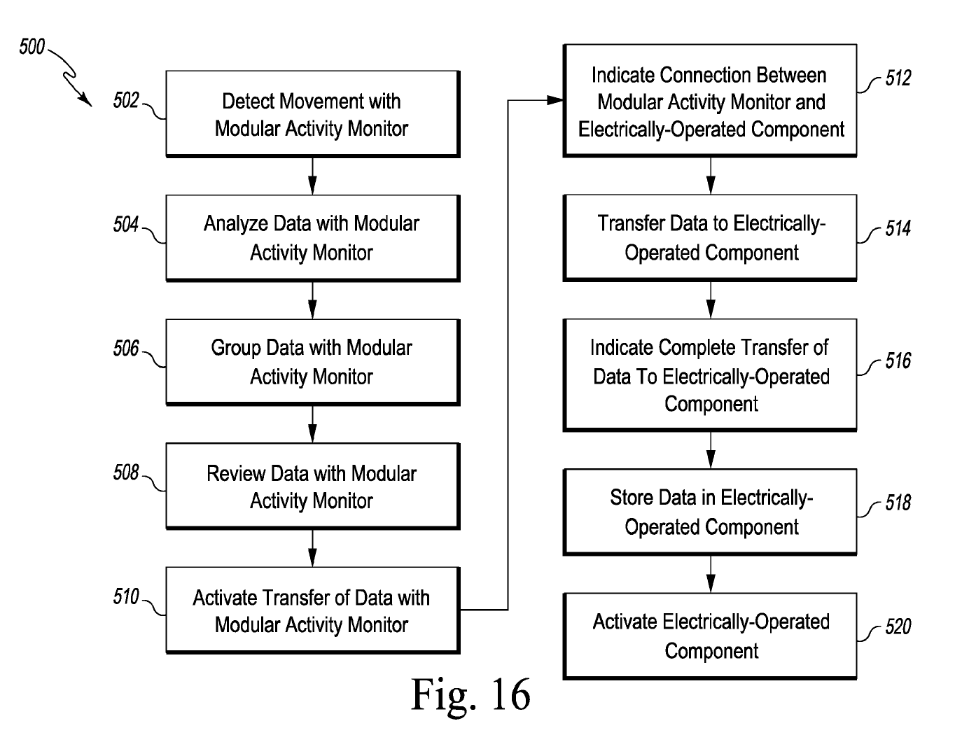

FIG. 16 is a flowchart of a method for operating a modular activity monitor.

### DETAILED DESCRIPTION

While the concepts of the present disclosure are susceptible to various modifications and alternative forms, specific exemplary embodiments thereof have been shown by way of example in the drawings and will herein be described in detail. It should he understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

Referring to FIG. 1, a modular activity monitor system 10 is shown. The modular activity monitor system 10 includes a first receiver 12 and a modular activity monitor 16 configured to be mounted in the first receiver 12. The first receiver 12 is coupled to an annular band 14 configured to be worn by a user. As shown in FIGS. 5-7, the system 10 also includes an electrically-operated component 33 having a second receiver 36 configured to receive the modular activity monitor 16. The electrically-operated component 33 is illustratively embodied as a toy 34 shown in FIG. 5, another toy 134 shown in FIG. 6, another toy 234 shown in FIG. 7, another toy 302 shown in FIG. 8, another toy 304 shown in FIG. 9, another toy 306 shown in FIG. 10, and another toy 308 shown in FIG. 11. It should be appreciated that in other embodiments the electrically-operated component 33 may take other forms consistent with the concepts outlined in this disclosure.

The modular activity monitor 16 is configured to determine the physical output of the user when the modular activity monitor 16 is worn by the user. As shown in FIG. 3, the modular activity monitor 16 includes an electronic controller 18, a sensor 20, and a battery 22 configured to power the other electronic components (e.g., sensor 20 and controller 18) of the monitor 16. The controller 18 is configured to receive movement data from the sensor 20, which may take the form of a pedometer to track a number of steps of the user. In other embodiments, the sensor 20 may be an accelerometer to track a speed of the user. In other embodiments, the sensor 20 may be a calorimeter to track a number of calories expended by the user.

The controller 18 includes a microprocessor 24, a memory 26, and an interface 28. The interface 28 is coupled to the microprocessor 24 and the sensor 20. The microprocessor 24 receives movement data from the sensor 20 through the interface 28 and stores the movement data in the memory 26. In an example, the sensor 20 is configured to determine the number of steps taken by a user over a determined period. In another example, the microprocessor 24 is configured to calculate the number of calories expended as a result of physical activity gathered by the sensor 20. In another example, the microprocessor 24 is configured to calculate a total distance traveled by the user as tracked by the sensor 20. In another example, the microprocessor 24 is configured to calculate a speed of the user as tracked by the sensor 20. In other embodiments, the microprocessor 24 may calculate various other physical activities of the user as tracked by the sensor 20.

Returning to FIG. 2, the receiver 12 includes a band mount 30 coupled to the annular band 14. An aperture 32 is defined in the band mount 30 and is sized to receive and secure the monitor 16 to the receiver 12. The band mount 30 may include any combination of flanges, slots, tabs, or other fastening means to secure the monitor 16 to the receiver 12.

As shown in FIG. 4, the receiver 36 of the electrically-operated component 33 includes a mount 46 that is sized to receive and secure the monitor 16 to the receiver 36. The receiver 36 also includes an electronic controller 44, a motor 40, and a battery 42 configured to power the other electronic components (e.g., motor 40 and controller 44) of the receiver 36. It should be appreciated that in other embodiments the receiver 36 may not include a motor but may include other electrically-operated components such as lights and/or speakers. A receptacle 38 is formed in the receiver 36, which is configured to engage a plug 37 of the modular activity monitor 16 when the monitor 16 is received in the mount 46 to electrically couple the monitor 16 to the other electrical components of the receiver 36. In some embodiments, the modular activity monitor 16 is permanently attached to the electrically-operated component 33.

The controller 44 is configured to receive user movement data from the modular activity monitor 16. The controller 44 includes a second microprocessor 48, memory 50, and an interface 52, as shown in FIG. 4. The microprocessor 48 is configured to receive user movement data from the modular activity monitor 16 and send a signal to the motor 40. In other embodiments, the microprocessor 48 may send signals to other electrically-operated components such as lights or speakers based on the user movement data. The memory 50 stores user movement data received from the modular activity monitor 16. The interface 52 couples the microprocessor 48 to the receptacle 38 so the microprocessor 48 is in communication with the modular activity monitor 16.

The modular activity monitor 16 is configured to record data, for example, user movement data, when coupled to the receiver 12. After recording user movement data, the modular activity monitor 16 may be removed and coupled to the receiver 36. The microprocessor 48 of the receiver 36 receives the user movement data from the modular activity monitor 16 and sends signals to the receiver 36 of the electrically-operated component 33. In an example, the amount of user movement recorded by the monitor 16 affects the activity of the electrically-operated component 33.

The modular activity monitor system 10 may include a watch, bracelet, headband (e.g., annular band 14) worn by a user. The modular activity monitor 16 attaches to the annular band 14. In some embodiments, the modular activity monitor 16 may otherwise attach to the user, for example, through a clip, pin, or other suitable attachment mechanism. In an example, the modular activity monitor 16 may be a pedometer that counts the steps of the user. In another example, the modular activity monitor 16 may calculate the total calories expended per day by the user, total miles/km traversed by the user, etc. In some embodiments, the modular activity monitor 16 may also function as a watch.

In some embodiments, the modular activity monitor 16 stores accumulated steps per day, per year, total, etc. The modular activity monitor 16 may be detachable from the annular band 14. When detached, the modular activity monitor 16 attaches to the electrically-operated component 33. In some examples, the electrically-operated component 33 may be a radio-controlled car, a doll, a plush figure, a car, an action figure, a game, or any suitable electronic product. In some examples, the modular activity monitor 16 may also connect to the electrically-operated component 33 by wireless transmissions, e.g. Bluetooth, infrared, or radio-frequency.

When the modular activity monitor 16 is connected to the electrically-operated component 33, the electrically-operated component 33 will function to different degrees depending on the amount of steps, calories, miles/km, etc. stored on the modular activity monitor 16. For example, if the electrically-operated component 33 is a toy car in accordance with the present disclosure has no modular activity monitor 16 attached or connected, the car will move slowly. Upon coupling the modular activity monitor 16 to the toy car, the toy car will function depending on the amount of steps, calories, miles/km, etc. stored on the modular activity monitor 16. For example, if the modular activity monitor 16 has accumulated a threshold number of steps that day, but has not reached a threshold for the week, the toy car will go fast only for a few inches but slow afterwards.

But if the modular activity monitor 16 connected to the toy car has accumulated a threshold number of steps daily and monthly, the toy car will move fast for a farther distance and may enable other features for example, lights and sounds effects. Accordingly, increased activity of the user allows increased functionality of the electrically-operated component 33. The more exercise the user does (e.g. the more steps accumulated) the more modes will be available on the electrically-operated component 33.

The programing of all the electronic items connectable to the modular activity monitor 16 will react differently depending on the user movement data accumulated by the modular activity monitor 16. The modular activity monitor 16 could also be connected to a computer, phone or tablet. In some embodiments, the modular activity monitor 16 includes applications that function according to accumulated exercise accomplished by the user. For example, the modular activity monitor 16 may show a stronger avatar if the user has more exercise accumulated.

In one embodiment, the modular activity monitor 16 compares the gathered user movement data to a plurality of thresholds. For example, if the modular activity monitor 16 is configured to track the steps of the user, various thresholds may be established, for example 10,000 steps, 20,000 steps, 30,000 steps, etc. Alternatively, in another embodiment, the modular activity monitor 16 may track various mileage thresholds, for example, 5 miles, 10 miles, 20 miles, etc. In other embodiments, other thresholds may be set. The modular activity monitor 16 tracks a level of the user based on various thresholds achieved. For example, the user may achieve level 1 by accomplishing the first threshold of steps, e.g. 10,000 steps. The user may then achieve level 2 by accomplishing the second threshold of steps, e.g. 20,000 steps. In some embodiments, the user levels may be achieved by accomplishing a combination of thresholds, e.g. 10,000 steps and 10 miles. The modular activity monitor 16 tracks the level of the user based on the various thresholds achieved by the user. The user level is saved in the modular activity monitor 16.

When the modular activity monitor 16 is coupled to the electrically-operated component 33, the electrically-operated component 33 is powered based on the user level achieved and stored in the modular activity monitor 16. In particular, various modes of the electrically-operated component 33 are unlocked based on the user level achieved and stored in the modular activity monitor 16. In some embodiments, if the user has not yet achieved a level (or the user is at level zero), the electrically-operated component 16 operates a primary mode disassociated with the user levels. For example, if the electrically-operated component 16 is a car, the primary mode may be to drive at a first speed. If the user has achieved a first user level, the car may operate at a second faster speed. As the user achieves higher levels, the car operates at even higher speeds or, in some embodiments, may operate various lights, sirens, or other suitable modes. In an embodiment wherein the electrically-operated component is an action figure, the plurality of modes may include various speeds, lighting configurations, or sounds. In some embodiments, the electrically-operated component 33 has a plurality of modes. Each of the plurality of modes is accessible by achieving various user levels with the modular activity monitor 16.

In some embodiments, the electrically-operated component 33 operates the functions dictated by the user level as long as the modular activity monitor 16 is coupled to the electrically-operated component 33. After the modular activity monitor 16 is removed from the electrically-operated component 33, the electrically-operated component 33 resets to the primary function; however, the modular activity monitor 16 continues to save the user level and user movement data. Accordingly, the modular activity monitor 16 can be coupled to various electrically-operated components 33 and each of these electrically-operated components 33 will operate functions based on the saved user level and user movement data. However, the electrically-operated component 33 resets so that other user can operate the electrically-operated component 33 based on that user's user level and user movement data. That is, a first user, with a first modular activity monitor 16, who has achieved user level 5, may operate the functions of an electrically-operated component 33 based on user level 5. A second user, with a second modular activity monitor 16, who has achieved level 7, may operate other functions of the same electrically-operated component 33 based on user level 7. In one embodiment, any number of electrically-operated components 33 may be operated by a modular activity monitor 16. Additionally, any electrically-operated component 33 may be operated by any number of modular activity monitors 16 based on the user level achieved with that modular activity monitor 16.

FIG. 12 illustrates a modular activity monitor 420 having an annular band 422. In other embodiments, the modular activity monitor 420 may not include an annular band 422, but rather, may attach to a user via another attachment mechanism. The modular activity monitor 420 includes a user interface 414 having a display 416 and a plurality of buttons 418. The display 416 illustrates user movement data, e.g. a number of steps, a distance, a speed, etc. The buttons 418 may be actuated to cycle through various features on the display 416. For example, actuating a button 418 may cause the display 416 to cycle from showing a number of steps to showing a distance, etc. In one embodiment, the display 416 may also cycle to a clock mode.

In one embodiment, the modular activity monitor 420 has wireless capabilities, for example, Bluetooth, infrared, radio-frequency, or internet connectivity. The modular activity monitor 420 may be positioned adjacent an electrically-operated component 33 to transmit a wireless signal to the electrically-operated component 33 via transmitter/receiver communications. That is, in one embodiment, the modular activity monitor 420 includes a transmitter (described below) and the electrically-operated component 33 includes a receiver (described below). In other embodiments, the modular activity monitor 420 and/or the electrically-operated component 33 includes a transceiver. The wireless signal transmits the user movement data and/or the user level from the modular activity monitor 420 to the electrically-operated component 33 so that the electrically-operated component 33 operates according to the user level and/or the user movement data.

In some embodiments, a button 418 may be activated on the electrically-operated component 33 to activate the electrically-operated component 33 for receiving a wireless signal. The electrically-operated component 33 may give an alert, e.g. an audible or visible alert, indicating that the electrically-operated component 33 is available to receive a wireless signal from the modular activity monitor 420. A button 418 may then be activated on the modular activity monitor 420 to transmit the wireless signal to the electrically-operated component 33. When the signal is received, the electrically-operated component 33 may give an additional alert, e.g. an audible or visual alert, to indicate that the wireless signal has been received from the modular activity monitor 420. The electrically-operated component 33 may then be operated based on the user level and/or user movement data saved on the modular activity monitor 420.

Referring to FIG. 13, the modular activity monitor 420 includes a sensor 424 that measures user movement data. The user movement data is transmitted from the sensor 424 to a controller 426 that includes a microprocessor 428 and a memory 430. The microprocessor 428 analyzes the user movement data to place the user movement data in data groups and determine whether any user levels have been achieved. The data, e.g. user levels, the user movement data, and the user movement data groups, are stored in the memory 430. In one embodiment, the data may be displayed on a display 416 of the modular activity monitor 420. For example, the user may cycle through the data on the display 416 by activating any of a number of buttons on the modular activity monitor 420. In some embodiments, the modular activity monitor 420 also includes a wireless internet (Wi-Fi) connection 434 that enables the data to be transferred via the internet to a device, e.g. computer, tablet, or the like. In some embodiments, the data may be stored on the device. In some embodiments, the device activates games or the like based on the user movement data. In some embodiments, the modular activity monitor 420 may also include a transmitter (or transceiver) 436 that wirelessly communicates the data to the electrically-operated component via radio-frequency transmissions, infrared transmissions, Bluetooth transmissions, or the like.

Referring to FIG. 14, the electrically-operated component 33 includes a receiver (or transceiver) 438 that receives signals from the transmitter 436, wherein the signals include the data, e.g. user levels, the user movement data, and the user movement data groups. In some embodiments, the electrically-operated component 33 includes a wireless internet (Wi-Fi) connection 440 that enables the data to be received from a device, e.g. computer, tablet, or the like, via the internet. The electrically-operated component 33 includes a controller 442 electrically coupled to the receiver 438 and/or the wireless internet connection 440. The controller 442 includes a memory 444 to store the data. In some embodiments, the data is temporarily stored. The controller 442 also includes a microprocessor 446 that operates the electrically-operated component 33 based on the data.

FIG. 15 illustrates another embodiment of a modular activity monitor 460. The modular activity monitor 460 gathers the user movement data as described above through a sensor similar to the sensors described above. The user movement data may be gathered while the user walks, jogs, runs, or otherwise exercises. The user movement data is stored in a memory similar to the memory described above. By pressing and holding the button 462, the user may review the various saved user movement data. By holding the button 462 for a predetermined period of time, for example, 2 seconds, the user movement data may be transferred to an electrically-operated component 33.

FIG. 16 illustrates a method 500 for operating the system 10. At step 502, the motion sensor detects the user movement and sends the user movement data to the microprocessor. For example, in an embodiment wherein the sensor is a pedometer, the sensor detects a number of steps of the user. Alternatively, an accelerometer may track a speed of the user or a calorimeter may track a number of calories expended by the user. At step 504, the microprocessor receives the user movement data and analyzes the data based on the user's activity. In particular, the microprocessor determines which data may be useful, e.g. which data was gathered while the user was moving and/or otherwise active and which data was related to the user being sedentary. At step 506, the controller stores the useful user movement data, e.g. user movement data indicative of activity, and groups the data, e.g. by date, week, month, total, etc. The data groups are stored and analyzed to determine whether the user had achieved any threshold values. If a threshold value is achieved, the microprocessor may store a user level for the user. In some embodiments, the memory is non-volatile or long-term memory. At step 508, the user may activate a button on the modular activity monitor to check the user's accumulated energy or activities by displaying various groups on the display. For example, the user may determine whether a total number of steps achieved is within a threshold to determine whether to remain active for a longer period of time.

At step 510, the user may activate and hold the modular activity monitor button for a predetermined time, e.g. 2 seconds, so that the groups of user movement data are transmitted to the electrically-operated component 33. The data may be sent by direct contact between the modular activity monitor and the electrically-operated component 33 or the data may be sent through wireless transmission, e.g. Bluetooth, radio-frequency, or infrared frequency. At step 512, the electrically-operated component 33 indicates that a connection has been made with the modular activity monitor via an alert. In some embodiments, the alert may be a visual indicator, for example, a light. In some embodiments, the alert may be an audible indicator, for example, a beep or the like.

At step 514, the electrically-operated component 33 receives the user movement data. In some embodiments, the electrically-operated component 33 receives all of the user movement data. Alternatively, or in addition to, the electrically-operated component 33 may receive the user movement data groups. Alternatively, or in addition to electrically-operated component 33 may receive the user levels. At step 516, the electrically-operated component indicates that the data groups have been received via another alert. In some embodiments, the alert may be a visual indicator, for example, a light. In some embodiments, the alert may be an audible indicator, for example, a beep or the like.

At step 518, the microprocessor of the electrically-operated component 33 stores the received data into a memory. At step 520, the electrically-operated component 33 is activated based on the user movement data, as described above. For example, various modes of the electrically-operated component 33 may be made available based on at least one of the total user movement data, the user movement data groups, and/or the user level. That is, the electrically-operated component 33 operates based on at least one of the total user movement data, the user movement data groups, and/or the user level. In some embodiments, when the electrically-operated component 33 is turned off, the user movement data is no longer stored in the electrically-operated component 33. Accordingly, another user may transmit their own user movement data, etc. to the electrically-operated component 33 and unlock other modes of the electrically-operated component 33 based on at least one of their total user movement data, their user movement data groups, and/or their user level.

While the disclosure has been illustrated and described in detail in the drawings and foregoing description, such illustrations and descriptions are to be considered as exemplary and not restrictive in character, it being understood that only illustrative embodiments have been shown and described and that all changes and modifications that come within the spirit of the disclosure are desired to be protected.

There arc a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A modular activity monitor system comprising:
a modular activity monitor configured to be coupled to a user, the modular activity monitor including:
a sensor configured to gather user movement data when coupled to the user,
a first controller coupled to the sensor and configured to store the user movement data, and
a transmitter configured to transmit the user movement data, and
an electrically-operated component including:
a receiver configured to receive the user movement data, and
a second controller configured to operate the electrically-operated component based on the user movement data,
wherein the first controller is configured to calculate a user level associated with a threshold value of user movement data, and the second controller is configured to operate the electrically-operated component in one of a plurality of modes based on the user level, and
wherein the electrically-operated component includes a vehicle, the plurality of modes including a plurality of lighting configurations and sounds activated by the vehicle.

2. The system of claim 1, wherein the modular activity monitor is configured to be coupled to an annular band that couples to the user.

3. The system of claim 1, wherein the modular activity monitor is configured to be coupled to the electrically-operated component to transmit the user movement data from the modular activity monitor to the electrically-operated component.

4. The system of claim 1, wherein the transmitter is operable to wirelessly transmit the user movement data to the receiver.

5. The system of claim 4, wherein the transmitter is operable to transmit the user movement data to the receiver via a radio frequency.

6. The system of claim 4, wherein the transmitter is operable to transmit the user movement data to the receiver via an infrared frequency.

7. (canceled)

8. The system of claim 1, wherein a plurality of user levels are each associated with exceeding one of a plurality of threshold values of user movement data, each of the plurality of user levels corresponding to one of the plurality of modes of the electrically-operated component.

9. The system of claim 1, wherein the second controller is configured to reset the mode of the electrically-operated component.

10. (canceled)

11. The system of claim 1, wherein the electrically-operated component is a vehicle, the plurality of modes including a plurality of speeds of the vehicle.

12. The system of claim 1, wherein the electrically-operated component is an action figure, the plurality of modes including a plurality of lighting configurations and sounds activated by the action figure.

13. The system of claim 1, wherein the electrically-operated component is an action figure, the plurality of modes including a plurality of speeds of the action figure.

14. The system of claim 1, wherein the first controller is operable to transmit the user movement data to an electronic device through a first internet connection.

15. The system of claim 14, wherein the second controller is operable to receive the user movement data from the electronic device through a second internet connection.

16-30. (canceled)

31. A method of operating an electrically-operated component comprising:
gathering user movement data with a sensor coupled to a user,
storing the user movement data in a controller coupled to the sensor,
transmitting the user movement data to an electrically-operated component, and
operating the electrically-operated component based on the user movement data.

32. The method of claim 31, further comprising coupling the sensor to an annular band that couples to the user.

33. The method of claim 31, further comprising coupling the controller to the electrically-operated component to transmit the user movement data from the controller to the electrically-operated component.

34. The method of claim 31, further comprising wirelessly transmitting the user movement data from the controller to the electrically-operated component.

35. The method of claim 34, further comprising wirelessly transmitting the user movement data from the controller to the electrically-operated component via a radio frequency.

36-45. (canceled)
